(19) United States
(12) Patent Application Publication
(10) Pub. No.: US 2006/0005675 A1
(43) Pub. Date: Jan. 12, 2006

(54) PROCESS OF USING A FIXED SIZE ROTARY CUTTER TO CUT PRODUCTS OF VARIABLE REPEAT LENGTHS

(75) Inventors: Bruce A. Scheffer, Valparaiso, IN (US); Thomas L. Nadrchal, Mokena, IL (US); Eric K. Lo, Hobart, IN (US)

Correspondence Address: HARTMAN & HARTMAN, P.C., 552 EAST 700 NORTH, VALPARAISO, IN, 46383, US

(73) Assignee: SCHEFFER, INC., Merrillville, IN (US)

(21) Appl. No.: 11/160,636

(22) Filed: Jul. 1, 2005

Related U.S. Application Data
(60) Provisional application No. 60/521,810, filed on Jul. 6, 2004.

(51) Int. Cl. B23D 25/02; B26D 1/56

(52) U.S. Cl. 83/37

(57) ABSTRACT

A process capable of using a fixed repeat rotary cutter for offline finishing of commercial offset web printed products having inconsistencies in repeat length. The process includes transporting a web at a linear speed in a first direction, operating a rotary cutter to singulate the products from the web by forming butt cuts within a waste portion between an adjacent pair of products and transverse to the first direction, causing the products to continue moving in the first direction, causing the products to move in a second direction transverse to the first direction, and then trimming the products to remove the waste portion between adjacent products as the products continue moving in the second direction. Each butt cut is produced with an individual straight knife mounted to a rotating knife cylinder of the rotary cutter, and the rotational speed of the knife cylinder is adjusted so that each butt cut separates pairs of preceding and trailing products as a result of being produced in the waste regions.

### CROSS REFERENCE TO RELATED APPLICATIONS

This application claims the benefit of U.S. Provisional Application No. 60/521,810, filed Jul. 6, 2004.

### BACKGROUND OF THE INVENTION

The present invention generally relates to printing equipment and processes. More particularly, this invention relates to a process of using a fixed size (fixed repeat) rotary cutter in offline finishing systems to produce printed products of different repeat lengths.

In a typical inline printing and finishing apparatus used in the printing industry, a moving web material passes through a series of printing presses at high speeds before being printed (wetted), dried, and cooled, after which the web undergoes a secondary finishing operation such as folding, perforating, gluing, die cutting, and rotary cutting to produce products of desired length. Rotary cutters sever the moving web material (typically paper), forming incisions generally transverse to the direction of web travel that separate the web into discrete predetermined lengths.

A rotary cutter typically comprises a pair of synchronized counter-rotating knife and anvil cylinders between which the web passes. The knife cylinder is equipped with one or more knife blades (or knives) that generally extend parallel to the rotational axis of the knife cylinder, and cut or perforate the web against the anvil cylinder. A single knife blade mounted to the knife cylinder produces a single cut, termed a butt cut, while a circumferentially adjacent pair of knife blades produces what has been termed a bleed cut and forms a trim piece or chip that must be removed and discarded.

To consistently produce cuts/perforations at the desired locations along the length of a moving web, the theoretical circumference of the knife/knives on the knife cylinder matches the circumference of the plate cylinder used to produce the printed product. In other words, one revolution of the knife cylinder matches one revolution of the printing plate cylinder. An unprinted area known as the blanket gap and present between adjacent repeat lengths must be removed from the final product. Removal of the blanket gap is performed with adjacent pairs of knives and the knife cylinder, and is known as a common bleed process.

As represented in FIG. 1, a web 10 (traveling in the direction of the arrows) can be printed with a printing plate cylinder (not shown) to produce multiple products 12 with each revolution of the printing plate cylinder, corresponding to a repeat length 14 on the web 10. The size of each product 12 is a fraction of the repeat length 14, with two products 12 per repeat length 14 depicted in FIG. 1, though it is understood that more products 12 per repeat length 14 are also possible. To cut or perforate the web 10, a knife cylinder (not shown) with a theoretical circumference matching the printing plate cylinder requires multiple knives to make the necessary multiple cuts/perforations with each revolution of the knife cylinder. As represented in FIG. 1, waste portions known as the head 16 and foot 18 are present at the upstream and downstream ends of each product 12, respectively. When the theoretical circumference of the knife cylinder matches the repeat length 14, the unwanted head 16 and foot 18 of each product 12 is cut with an adjacent pair of knives on the knife cylinder to produce bleed cuts 20, after which the head 16 and foot 18 are removed by a waste extraction system immediately downstream of the rotary cutter. Removal of the head 16 and foot 18 by this process is known as a full bleed process.

Finishing processes as described above are generally in the form of inline finishing where the product is finished directly after it is printed in one complete process. Such an operation permits the use of a fixed size (fixed repeat) rotary cutter, with which the printing plate cylinder is synchronized in what is termed a print-to-cut registration control. In contrast, in offline finishing operations the printed product is rewound into rolls that may be stored for a period of time before finishing or shipped to a remote location where the finishing process takes place. Offline finishing becomes much more complex due to the added variables inherent to the rewinding and storage of the printed rolls. For example, tension upsets within the rewinding process along with humidity variations in the storage of printed rolls produce inconsistencies in the print length. These inconsistencies must be taken into account when the product is cut to its final length with a rotary cutter. Unlike inline finishing where the repeat lengths and the product print lengths are consistent and print-to-cut registration is an acceptable method for controlling the location of the cut with respect to the products, cut-to-print registration control must be used to match the location of the knives on the knife cylinder to the inconsistent print lengths inherent to offline finishing. Whereas typical print-to-cut methods are able to adjust the path length of the web to match a constant speed knife, cut-to-print technology requires the ability to adjust the rotational speed of the cutting cylinders during operation as the printed web is scanned for the precise locations of the cuts to be made.

Although the majority of inline finishing is performed on fixed repeat length printing presses, some inline finishing takes place on variable repeat length presses as well. When rotary cutters are placed on a variable repeat press, as the printing plate cylinder is changed to a new size to produce a smaller repeat length, the printed web speed is reduced. As the printed web speed is reduced, pull rolls within the inline equipment must be slowed down to match the new web speed. If common or full bleed products are to be produced with the rotary cutter, the knife and anvil cylinders must be replaced to match the new plate cylinder circumference. This is a very difficult and time-consuming process to change very large and heavy cylinder cassettes that hold the knife and anvil cylinders within the rotary cutter. A select few printers utilize double-edge knife trimmers along with a rotary cutter to produce full bleed products in inline applications. To achieve this feat, these printers adjust the speed of all pull rolls within the inline finishing equipment when the printing cylinders are changed to different sizes within the printing units while the cylinders in the rotary cutter remain unchanged. The rotational speed of the cylinders also remain the same, producing a smaller single butt cut product due to the fact that the surface speed of the oversized cylinders is faster than the printed web. The head and foot of the images are trimmed by single or double-edge knife trimmers located after the rotary cutter. Such printers also utilize the print-to-cut method of registration for product control.

Although the above-noted technology has been applied to inline finishing operations, there remains a need for a process capable of cutting variable repeat printed products in an offline finishing process without the need for cassette changes.

### BRIEF SUMMARY OF THE INVENTION

The present invention provides a process capable of using a fixed repeat rotary cutter for offline finishing of commercial offset web printed products. As an offline finishing process, the web may be printed by different repeat-size printing presses, rewound, and distributed to the rotary cutter for finishing at a later date, with the result that inconsistencies in repeat length on the web are inherently likely to occur from product to product. With the process of this invention, printed products from multiple printing presses of different repeat sizes can be cut to length with a fixed repeat rotary cutter and waste portions between products can be removed without interfering with the flow of the web.

The offline finishing process of this invention includes transporting the web at a linear speed in a first direction, operating the rotary cutter to singulate the products from the web by forming butt cuts within a waste portion between an adjacent pair of products and transverse to the first direction, causing the products to continue moving in the first direction, causing the products to move in a second direction transverse to the first direction, and then trimming the products to remove the waste portion of the products as the products continue moving in the second direction. According to the invention, each butt cut is produced with an individual straight knife mounted to a rotating knife cylinder of the rotary cutter, each butt cut separates pairs of preceding and trailing products as a result of being produced in the waste region, and the placement of each butt cuts within the waste portions is controlled by adjusting the rotational speed of the knife cylinder.

In view of the above, it can be seen that a significant advantage of this invention is that the process is capable of cutting variable repeat printed products in an offline finishing process without the need of cassette changes to the rotary cutter. Instead, only the rotational speed of a fixed repeat (size) rotary cutter need be increased to compensate for shorter repeat lengths, while the web speed remains essentially constant.

Other objects and advantages of this invention will be better appreciated from the following detailed description.

### BRIEF DESCRIPTION OF THE DRAWINGS

FIG. 1 is a plan view of a portion of a printed web, with head and foot portions of individual printed products identified in accordance with conventional practice.

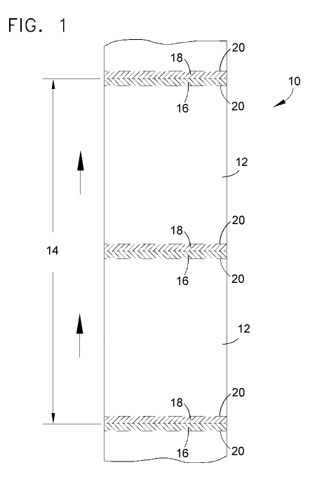

FIG. 2 is a plan view depicting the processing of a printed web in accordance with the present invention.

### DETAILED DESCRIPTION OF THE INVENTION

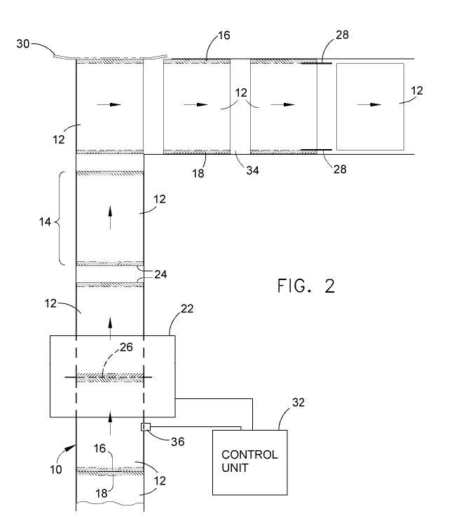

Illustrated in FIG. 2 is an offline finishing operation that is able to make use of a fixed repeat rotary cutter to separate a web 10 into individual products 12, whose repeat lengths 14 may be inconsistent as an inherent result of the web 10 being finished offline. The apparatus for performing the finishing operation of this invention is only schematically represented in FIG. 2, as its components are well known to those skilled in the art and therefore do not require a detailed explanation or illustration to obtain a full understanding of the invention.

As represented in FIG. 2, a knife cylinder 22 of the rotary cutter is strictly limited to producing butt cuts 24, each being made with an individual straight knife 26 transverse to the web 10 as it travels in the direction indicated by arrows. As such, the rotary cutter singulates the products 12 by forming the butt cuts 24 within the waste portion formed by the head 16 and foot 18 of and between each adjacent pair of products 12, but does not remove the head 16 and foot 18 of each product 12. Instead, the final trim operation is performed with a pair of knife trimmers 28. In order to be oriented for trimming with the knife trimmers 28, the singulated products 12, which may be accelerated to further separate the individual products 12, are sent through a ninety-degree bump turn 30 that changes the travel direction of the products 12 from a head-first flow direction to a sideways flow direction. As the products 12 travel sideways on a conveyor 34 or other suitable transport apparatus, the head 16 and foot 18 of each product 12 are removed with the knife trimmers 28, which may be, for example, a pair of rotating knives. While FIG. 2 shows each butt cut 24 as being formed roughly in the middle of each waste portion between adjacent products 12 (i.e., the combined head 16 and foot 18 of adjacent products 12), so that a head 16 and foot 18 of each product 12 must be removed with the trimmers 28, it is also within the scope of this invention that the butt cuts 24 can be formed to completely remove the waste portion from the fore or rear end of each product 12, such that only a single trimmer 28 is required to remove the entire waste portion remaining attached to the rear or fore end, respectively, of each product 12.

As a result of its knife cylinder 22 being strictly limited to performing each butt cut 24 with an individual straight knife 26, it has been determined that the rotary cutter can be operated in an over-speed condition relative to the web 10 because the knife 26 comes in contact with the web 10 for only a fraction of a second. Stated another way, the rotational speed of the knife cylinder 22 can be increased to cause its surface speed (tangential velocity at the knife 26) to be faster than the linear speed of the web 10. This momentary contact with the web 10 does not adversely affect the web 10 if only a butt cut is performed, as only a momentary pulling action occurs locally in the web 10. In contrast, attempting to simultaneously remove the head 16 and foot 18 of each product 12 with double knives carried by the knife cylinder 22 (i.e., to produce a bleed cut) would result in sufficiently prolonged contact to interfere with the continuous flow of the web 10 and the chip removal device, e.g., pins, (not shown) conventionally employed to remove the head 16 and foot 18 immediately downstream of the rotary cutter. Attempts to perform contour cuts with the rotary cutter are also not practical due to prolonged contact that would occur between a contour knife and the web 10. Notably, attempting to operate the rotary cutter in an under-speed condition relative to the web 10 would also result in unacceptably prolonged contact with the web 10 that would interfere with continuous web flow. Because the rotary speed of the knife cylinder 22 can be readily adjusted to the repeat length 14 of the products 12 using known cut-to-print registration control techniques, the process of this invention avoids the prior practice of changing the knife and anvil cylinders (in a cylinder cassette) of the rotary cutter.

The above-described process of this invention is to be distinguished from finishing operations for variable repeat inline applications, in which the knife cylinder speed of the rotary cutter remains the same and the web speed is reduced to adjust for differences in repeat lengths. With the offline finishing process of this invention, only the speed of the rotary cutter is increased to compensate for shorter repeat lengths, while all pull rolls and the web speed remain the same. The present invention is also distinguishable from print-to-cut registration control techniques previously employed to adjust for the inconsistencies of the printed products that inherently arise in offline finishing applications.

In setting up the rotary cutter to carry out the process of this invention, the web speed and the maximum repeat length that will be encountered establish the minimum knife cylinder circumference and speed for the rotary cutter. Thereafter, the repeat lengths 14 of the products 12 is sensed with a registration scanning unit 36 of a type known in the art, and the rotational speed of the knife cylinder 22 is adjusted thereto with a control unit 32 to ensure that each butt cut 24 will be formed between the foot 16 and head 18 of each successive pair of products 12, respectively, as shown in FIG. 2. The increase in cylinder speed required for a decrease in product repeat length can be easily calculated by multiplying the ratio of the knife cylinder circumference to the reduced repeat size by the aforementioned minimum cylinder speed of the rotary cutter. This calculation can be continuously performed by the control unit 32 to enable and control the ability of the knife cylinder 22 to be advanced and retarded as need to adjust to inconsistencies of the printed product 12 within the web 10 and from roll to roll. A calculation example follows.
Knife cylinder circumference=40.00 inches (about 100 cm)
Smaller repeat size=30.00 inches (about 75 cm)
Minimum knife cylinder speed=100 rpm
Calculated overspeed=40.00/30.00×100 rpm=133.33 rpm, or an increase of about 33.3% in rotational speed of the knife cylinder 22.

While the invention has been described in terms of a preferred embodiment, it is apparent that other forms could be adopted by one skilled in the art. Therefore, the scope of the invention is to be limited only by the following claims.

What is claimed is:

1. An offline finishing process that makes use of a rotary cutter to sever a web into separate products having repeat lengths, the process comprising the steps of:
transporting the web at a linear speed in a first direction, the web comprising products with each adjacent pair of products being separated by a waste portion;
operating the rotary cutter to singulate the products from the web by forming butt cuts within the waste portion between each adjacent pair of products and transverse to the first direction, each of the butt cuts being produced with an individual straight knife mounted to a rotating knife cylinder of the rotary cutter, the rotational speed of the knife cylinder being adjusted so that each butt cut separates pairs of preceding and trailing products and each product has attached thereto at least a portion of the waste portion as a result of each butt cut being produced in the waste regions between adjacent pairs of products;
causing the products to continue moving in the first direction;
causing the products to move in a second direction transverse to the first direction; and then
trimming the products to remove the waste portion of the products as the products continue moving in the second direction.

2. An offline finishing process according to claim 1, wherein during the step of causing the products to continue moving in the first direction, the products are separated by being sequentially accelerated.

3. An offline finishing process according to claim 1, wherein during the step of causing the products to move in the second direction the products are sent through a ninety-degree bump turn that changes the path of the products from a head-first flow direction to a sideways flow direction.

4. An offline finishing process according to claim 1, wherein the knife cylinder is limited to performing the butt cuts and each butt cut is formed with an individual straight knife.

5. An offline finishing process according to claim 1, wherein the repeat lengths of the products vary along the web yet the knife cylinder forms each of the butt cuts within the waste portion between each successive pair of preceding and trailing products, respectively.

6. An offline finishing process according to claim 1, wherein the butt cuts are formed so as to entirely separate the waste portion from one end of each product.

7. An offline finishing process according to claim 1, wherein the butt cuts are formed within the waste portion between each successive pair of preceding and trailing products so that a foot portion of the waste portion remains attached to the preceding product of each successive pair and a head portion of the waste portion remains attached to the trailing product of each successive pair.

8. An offline finishing process according to claim 1, wherein the rotational speed of the knife cylinder is adjusted by sensing the repeat lengths of the products.

9. An offline finishing process according to claim 1, further comprising the step of increasing the rotational speed of the knife cylinder to cause the surface speed of the knife cylinder to be greater than the linear speed of the web, causing a momentary pulling action to locally occur in the web.

10. An offline finishing process according to claim 1, wherein during the process the rotational speed of the knife cylinder is not sufficiently reduced to cause the surface speed of the knife cylinder to be less than the linear speed of the web.

11. An offline finishing process according to claim 1, further comprising the step of setting up the rotary cutter to carry out the process by determining a minimum circumference of the knife cylinder based on the linear speed of the web and a maximum of the repeat lengths of the products.

12. An offline finishing process that makes use of a fixed repeat rotary cutter to sever a web into separate products having variable repeat lengths, the process comprising the steps of:
transporting the web at a substantially constant linear speed in a first direction;
operating the rotary cutter to singulate the products from the web by forming butt cuts transverse to the first direction, each of the butt cuts being produced with an individual straight knife mounted to a rotating knife cylinder of the rotary cutter, the rotational speed of the knife cylinder being adjusted so that each butt cut separates pairs of preceding and trailing products by separating a foot of the preceding product from a head of the trailing product;
sending the products through a ninety-degree bump turn that changes the movement of the products from a head-first orientation in the first direction to a side-first orientation in a second direction transverse to the first direction; and then
trimming the products to remove the head and foot of the products as the products continue moving in the second direction.

13. An offline finishing process according to claim 12, wherein the knife cylinder is limited to performing the butt cuts and each butt cut is formed with an individual straight knife.

14. An offline finishing process according to claim 12, wherein the repeat lengths of the products vary along the web yet the knife cylinder forms each of the butt cuts between the foot and head of each successive pair of preceding and trailing products, respectively.

15. An offline finishing process according to claim 12, further comprising the step of sensing the repeat lengths of the products to adjust the rotational speed of the knife cylinder when forming the butt cut between the foot and head of each successive pair of preceding and trailing products, respectively.

16. An offline finishing process according to claim 15, further comprising the step of increasing the rotational speed of the knife cylinder to cause the surface speed of the knife cylinder to be greater than the linear speed of the web, causing a momentary pulling action to locally occur in the web.

17. An offline finishing process according to claim 15, wherein during the process the rotational speed of the knife cylinder is not sufficiently reduced to cause the surface speed of the knife cylinder to be less than the linear speed of the web.

18. An offline finishing process according to claim 15, further comprising the step of setting up the rotary cutter to carry out the process by determining a minimum circumference of the knife cylinder based on the linear speed of the web and a maximum of the repeat lengths of the products.
